(19) United States
(12) Patent Application Publication
(10) Pub. No.: US 2018/0170224 A1
(43) Pub. Date: Jun. 21, 2018

(54) VEHICLE SEAT COVERING MATERIAL, VEHICLE SEAT INCLUDING THE SAME, AND METHOD FOR MANUFACTURING THE VEHICLE SEAT COVERING MATERIAL

(71) Applicants: Hyundai Motor Company, Seoul (KR); Kia Motors Corporation, Seoul (KR)

(72) Inventors: Kyungnam KIM, Seoul (KR); KieYoun JEONG, Hwaseong-si (KR); Shin-Tae BAE, Hwaseong-si (KR); Hyena HWANG, Ulsan (KR); Sungjoon HONG, Seoul (KR); Han Seok KIM, Seoul (KR)

(73) Assignees: Hyundai Motor Company, Seoul (KR); Kia Motors Corporation, Seoul (KR)

(21) Appl. No.: 15/490,057

(22) Filed: Apr. 18, 2017

(30) Foreign Application Priority Data
Dec. 21, 2016 (KR) 10-2016-0175339

(51) Int. Cl. B60N 2/58; C09K 21/14; D06P 3/52; D04B 1/14; D04B 37/00; D04B 13/02

(52) U.S. Cl. CPC B60N 2/58; C09K 21/14; D06P 3/52; B60N 2/5891; D04B 37/00; D04B 13/02; D04B 1/14

(57) ABSTRACT

A vehicle seat covering material, a vehicle seat including the same, and a method for manufacturing the vehicle seat covering material are disclosed, wherein the vehicle seat covering material includes a first knit fabric configured to form a surface of the vehicle seat covering material; and a second knit fabric located to an opposite surface of to a surface of the first knit fabric, and configured to include flame retardant fibers.

### CROSS-REFERENCE(S) TO RELATED APPLICATION

The present application claims priority to Korean Patent Application No. 2016-0175339, filed on Dec. 21, 2016, the entire contents of which is incorporated herein for all purposes by this reference.

### BACKGROUND OF THE INVENTION

### Field of the Invention

The present invention relate to a vehicle seat covering material, a vehicle seat including the same, and a method for manufacturing the vehicle seat covering material.

### Description of Related Art

A vehicle seat covering material is flame-retardant treated through coating or simultaneous dyeing in the same bath to satisfy the Federal Motor Vehicle Safety Standard No. 302 (FMVSS302).

Bromine-based flame retardants have been widely used for flame retardant treating. However, the bromine-based flame retardants are harmful to humans and are accumulated into living organisms and Earth's environments in a harmful manner, wherein the use of bromine-based flame retardants is becoming increasingly regulated.

To address the issue an eco-friendly flame retardant treatment technology is needed for the flame retardant treatment of vehicle seat covering materials.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to provide a double-knit covering material configured to use flame retardant fibers, and a method for manufacturing the same.

Additional aspects of the invention will be set forth in part in the description which follows and, in part, will be obvious from the description, or may be learned by practice of the invention.

In accordance with an aspect of the present invention, a vehicle seat covering material includes a first knit fabric configured to form a surface of the vehicle seat covering material, and a second knit fabric located to an opposite surface of to a surface of the first knit fabric configured to include flame retardant fibers.

The second knit fabric may include flame retardant fibers formed by the polymerization of polyethylene phthalate (PET) and phosphorous-based flame retardants during fabrication of the PET.

The second knit fabric may include flame retardant fibers formed by polymerization of PET and 3-hydroxyphenylphosphinyl-propanoic acid (3HPP) during fabrication of the PET.

The second knit fabric may include flame retardant fibers formed by polymerization of phosphorous-based flame retardants, terephthalic acid, and ethylene glycol during the polymerization of the terephthalic acid and the ethylene glycol.

The second knit fabric may include flame retardant fibers formed by the polymerization 3HPP, terephthalic acid, and ethylene glycol during polymerization of the terephthalic acid and the ethylene glycol.

The first knit fabric may be formed of PET fibers.

In accordance with another aspect of the present invention, a vehicle seat includes the seat and a seat covering material configured to cover the seat. The seat covering material includes a first knit fabric configured to form a surface of the seat covering material, and a second knit fabric located on the opposite surface of the surface of the first knit fabric and configured to include flame retardant fibers.

The second knit fabric may include flame retardant fibers formed by PET and phosphorous-based flame retardants during the fabrication of the PET.

The second knit fabric may include flame retardant fibers formed by the polymerization of PET and 3HPP during the fabrication of the PET.

The second knit fabric may include flame retardant fibers formed by the polymerization of phosphorous-based flame retardants, terephthalic acid, and ethylene glycol during the polymerization of the terephthalic acid and the ethylene glycol.

The second knit fabric may include flame retardant fibers formed by the polymerization of 3HPP, terephthalic acid, and ethylene glycol during the polymerization of the terephthalic acid and the ethylene glycol.

The first knit fabric may be formed of PET fibers.

In accordance with another aspect of the present invention, a method for manufacturing a vehicle seat covering material includes fabricating, by a circular knitting machine, a double-knit structured knitted fabric composed of a first knit fabric and a second knit fabric including flaming retardant fibers disposed to one surface of the first knit fabric, and dyeing the formed knit fabric.

Dyeing the formed knit fabric may include dyeing the knit fabric at a predetermined temperature for a predetermined time using the formed knit fabric, dye, and a stabilizer.

The method may further include forming a vehicle seat covering material by thermally treating the dyed knit fabric.

The method may further include during fabrication of PET, forming flame retardant fibers through the polymerization of the PET and phosphorous-based flame retardants.

The method may further include during the fabrication of PET, forming flame retardant fibers through the polymerization of PET and 3HPP.

The method may further include during polymerization of terephthalic acid and ethylene glycol, forming flame retardant fibers through polymerization of phosphorous-based flame retardants, the terephthalic acid, and the ethylene glycol.

The method may further include during polymerization of terephthalic acid and ethylene glycol, forming flame retardant fibers through polymerization of 3HPP, the terephthalic acid, and the ethylene glycol.

The methods and apparatuses of the present invention have other features and advantages which will be apparent from or are set forth in more detail in the accompanying drawings, which are incorporated herein, and the following Detailed Description, which together server to explain certain principles of the present invention.

### BRIEF DESCRIPTION OF THE DRAWINGS

FIG. 1 is an enlarged view illustrating a seat covering material according to an exemplary embodiment of the present invention.

FIG. 2 is an enlarged view illustrating a vehicle seat covering material according to an exemplary embodiment of the present invention.

FIG. 3 is a flowchart illustrating a method for manufacturing the vehicle seat covering material according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Throughout the specification of the present invention, when it is assumed that a certain part includes a certain component, the term “comprising or including” means that a corresponding component may further include other components unless context clearly indicates otherwise.

The terms “a”, “an”, “one”, “the” and other similar terms include both singular and plural forms, unless context clearly dictates otherwise.

Identification numbers for use in respective operations to be described later are used for convenience of description and better understanding of the present invention, do not describe the order or sequence of the respective operations of the present invention, and the respective operations of the present invention may be carried out in a different way from the order written in the present invention, unless context of each operation clearly indicates a specific order.

A vehicle seat covering material, a vehicle seat having the same, and a method for manufacturing the vehicle seat covering material according to various embodiments of the present invention will hereinafter be described with reference to the appended drawings.

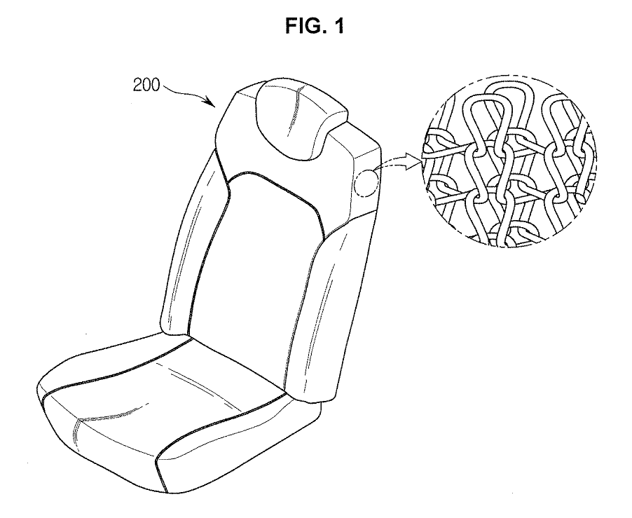

Referring to FIG. 1, the vehicle may include a seat 200 disposed in an internal compartment thereof wherein a user or passenger can sit thereon. To allow the covering material of vehicle seat 200 to satisfy the Federal Motor Vehicle Safety Standard No. 302 (FMVSS302), flame retardant treatment based on coating or simultaneous dyeing in the same bath is carried out.

When the seat covering material is a textile fabric, flame retardant treatment is carried out through coating. For example, when a fabric in which acryl binder and flame retardant powder are mixed is applied with a thin thickness onto the surface of the fabric, the fabric may have flame retardant characteristics.

When the seat covering material is a knit fabric flame retardants are injected into a dyeing machine during the dyeing of the covering material. During the dyeing process the flame retardants are attached onto the covering material along with the dye, wherein the flame retardant characteristics of the covering material can be guaranteed.

The use of bromine-based flame retardants is becoming increasingly regulated as the flame retardants accumulate over time and are harmful to living organisms and Earth's environment. Therefore, although phosphorous-based flame retardants have been widely used as substitute materials, the phosphorous-based flame retardants continuously generate various quality problems such as chlorosis caused by migration, water spots, corrosion, smell, etc.

When a flame retardant treatment is applied to a vehicle seat cover material, the following embodiment of the present invention is directed to providing a vehicle seat cover material capable of being an eco-friendly flame-retardant treatment, and a method for manufacturing the same. In addition, the following embodiment may provide a seat covered with the above-mentioned covering material and a vehicle including the seat.

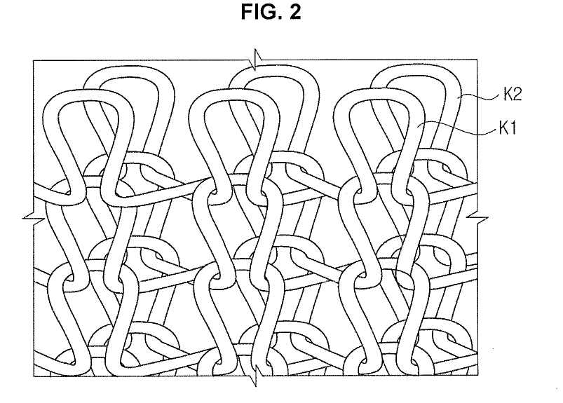

The embodiment of the present invention will hereinafter be given with reference to FIG. 1 and FIG. 2.

The seat covering material according to various embodiments includes flame retardant fibers to satisfy the flame retardant characteristics without using an additional flame retardant treatment. As a result, the exemplary seat covering material may solve the migration problem caused by flame retardants and the toxicity problems caused by bromine-based flame retardants. Generally, flame retardants including dye and a stabilizer are added during the dyeing process to perform a flame retardant treatment. Since the seat covering material according to the present embodiment uses flame retardant fibers, flame retardants may be omitted from the dyeing process. In addition, flame retardants may deteriorate the dyeing effectiveness and properties of the material. Flame retardants are omitted from the dyeing process, wherein smaller quantities of dyes and stabilizers may be used when compared to a case in which flame retardants are used.

Flame retardant fibers contained in the seat covering material according to the embodiment can be polymerized with phosphorous-based flame retardants during the manufacturing process of polyethylene phthalate (PET).

The PET fibers may be fabricated by spinning of PET generated by condensation polymerization of terephthalic acid and ethylene glycol.

During fabrication of such PET, flame retardant fibers according to the embodiment may denote PET fibers having flame-retardant performance, manufactured by the polymerization of phosphorous-based flame retardants and PET.

In the present case, as a representative example of phosphorous-based flame retardants added to the fabrication process of PET, 3-hydroxyphenylphosphinyl-propanoic acid (3HPP) may be used.

The seat covering material may be classified into a textile fabric and a knit fabric. to omit flame retardant treatment from the dyeing process, the seat covering material according to the embodiment is manufactured by applying the aforementioned flame retardant fibers to the knit fabric. In accordance with the method for fabricating the seat covering material by making woven fibers through knitting work, the knit fabric may be fabricated as a tricot, knit, raschel, or suede fabric according to the design pattern or usage. Although the seat covering material according to the embodiment may be a knit fabric manufactured by knitting, the scope or spirit of the manufacturing process of the present invention is not limited thereto.

The seat covering material according to the embodiment may have a double knit structure in which a knit fabric includes a surface and a back surface, as shown in FIG. 1 and FIG. 2.

That is, a first knit fabric K1 forming the surface of the knit fabric may be formed of PET fibers, and a second knit fabric K2 forming the back surface of the knit fabric may be formed of the above-mentioned flame retardant fibers.

In the case of fabricating the seat covering material having a double knit structure, the quality deterioration caused by flame retardant treatment can be solved. In addition, assuming that flame retardant fibers are applied to the entire seat covering material, unique properties of the seat covering material may be deteriorated because flame retardant fibers have a lower strength and lower torque compared to PET fibers.

When flame retardant fibers are applied only to the back surface of the aforementioned double-knit structure, the above-mentioned problems may also be solved.

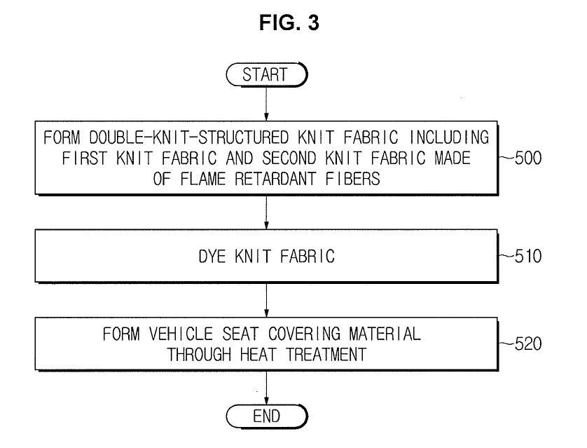

FIG. 3 is a flowchart illustrating a method for manufacturing the vehicle seat covering material according to an embodiment of the present invention. Referring to FIG. 3, a circular knitting machine makes a double-knit fabric including a first knit fabric K1 and a second knit fabric K2 formed of flame retardant fibers (Operation 500). The dyeing machine may dye the double-knit fabric.

The circular knitting machine may fabricate general PET fibers and flame retardant fibers as a double-knit fabric. PET fibers may be fabricated by the spinning of PET generated by condensation polymerization of terephthalic acid and ethylene glycol.

During fabrication of such PET, flame retardant fibers contained in the seat covering material according to the embodiment may be manufactured by polymerization of phosphorous-based flame retardants and PET. That is, during fabrication of such PET, flame retardant fibers may denote PET fibers having flame-retardant performance, manufactured by polymerization of phosphorous-based flame retardants and PET.

In the present case, as a representative example of phosphorous-based flame retardants added to the PET fabrication process, 3HPP may be used.

When the double-knit fabric is manufactured, dye and a stabilizer may be added to the dyeing machine to dye the resultant knit fabric, and the dyeing process is performed at a predetermined temperature (e.g., 130° C.) for a predetermined time (e.g., 2 hours). The stabilizer may include a lightfastness thickening agent, a conditioner, and an oxidizing agent.

When flame retardant treatment caused by flame retardants is performed together with the dyeing process, for example, a dye of 5 wt % to 6 wt %, a stabilizer of 15 wt %, and a flame retardant of 8 wt % may be added to the dyeing process. In the case of using the double-knit fabric based on flame retardant fibers shown in the above-mentioned embodiment, flame retardants may be omitted from the dyeing process. Flame retardants may deteriorate the dyeing characteristics and properties. Flame retardants may be omitted from the dyeing process, wherein a smaller amount of dyes and stabilizers may be used as compared to the case in which flame retardants are used. In other words, according to the method for manufacturing the vehicle seat covering material, a dye of 4 wt % and a stabilizer of 14 wt % less than those of the above case in which flame retardants are used may be used in the dyeing process.

When the dyeing process of the knit fabric is completed, heat treatment is performed on the dyed knit fabric, resulting in the fabrication of the vehicle seat covering material (Operation 520). When the dyeing process is completed, heat treatment is needed to fix and soften the resultant seat covering material.

The following Table 1 illustrates various properties of the seat covering material, quoted test standards, reference values, and numerical values of the respective properties according to an embodiment of the present invention.

TABLE 1

| | Quoted test | | |
|---|---|---|---|
| | standards | Reference | |
| Properties | (reference) | values | Examples |
| Tensile strength (kgf) | ASTM D5035 | 40 or higher | 49.5 |

| | | | |
|---|---|---|---|
| Elongation | State | 50~160 | 115.8 |
| (%) | Immersion | 15 or less | 4.2 |

| | | | |
|---|---|---|---|
| Constant load elongation | | 60 or less | 36 |
| (%) | | | |
| Tearing strength (kgf) | KS K 0534 | 3 or higher | 5.6 |
| Bursting strength (kgf) | KS K 0350 | 15 or higher | 28 |
| Abrasion resistance | KS K 0540 | 3 or higher | 3 |
| (level) | | | |
| Contraction rate caused | — | 3 or less | 0.2 |
| by immersion (%) | | | 0.3 |
| Light stability (level) | ISO 105-B02 | 3 or higher | 4 |
| Flammability | FMVSS22 | 100 or less | Self- |
| (mm/minute) | | | extinguishing |

Referring to flammability from among the properties shown in Table 1, it may be preferable that a reference value is equal to or less than 100. However, the seat covering material having a double knit structure in which flame retardant fibers are used is characterized in that the seat covering material has the self-extinguishing property.

As is apparent from the above description, the seat covering material according to the embodiment can obviate quality deterioration caused by flame retardant treatment.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “forwards” and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle seat covering material comprising:
a first knit fabric configured to form a surface of the vehicle seat covering material; and
a second knit fabric located to an opposite surface of to a surface of the first knit fabric, and configured to include flame retardant fibers.

2. The vehicle seat covering material according to claim 1, wherein the second knit fabric includes the flame retardant fibers formed by polymerization of polyethylene phthalate (PET) and phosphorous-based flame retardants during fabrication of the polyethylene phthalate (PET).

3. The vehicle seat covering material according to claim 1, wherein the second knit fabric includes the flame retardant fibers formed by polymerization of polyethylene phthalate (PET) and 3-hydroxyphenylphosphinyl-propanoic acid (3HPP) during fabrication of the polyethylene phthalate (PET).

4. The vehicle seat covering material according to claim 1, wherein the second knit fabric includes the flame retardant fibers formed by polymerization of phosphorous-based flame retardants, terephthalic acid, and ethylene glycol during polymerization of the terephthalic acid and the ethylene glycol.

5. The vehicle seat covering material according to claim 1, wherein the second knit fabric includes the flame retardant fibers formed by polymerization of 3-hydroxyphenylphosphinyl-propanoic acid (3HPP), terephthalic acid, and ethylene glycol during polymerization of the terephthalic acid and the ethylene glycol.

6. The vehicle seat covering material according to claim 1, wherein the first knit fabric is formed of polyethylene phthalate (PET) fibers.

7. A vehicle seat comprising:
a seat; and
a seat covering material configured to cover the seat,
wherein the seat covering material includes:
a first knit fabric configured to form a surface of the seat covering material; and
a second knit fabric located to an opposite surface of to a surface of the first knit fabric, and configured to include flame retardant fibers.

8. The vehicle seat according to claim 7, wherein the second knit fabric includes the flame retardant fibers formed by polymerization of polyethylene phthalate (PET) and phosphorous-based flame retardants during fabrication of the polyethylene phthalate (PET).

9. The vehicle seat according to claim 7, wherein the second knit fabric includes the flame retardant fibers formed by polymerization of polyethylene phthalate (PET) and 3-hydroxyphenylphosphinyl-propanoic acid (3HPP) during fabrication of the polyethylene phthalate (PET).

10. The vehicle seat according to claim 7, wherein the second knit fabric includes the flame retardant fibers formed by polymerization of phosphorous-based flame retardants, terephthalic acid, and ethylene glycol during polymerization of the terephthalic acid and the ethylene glycol.

11. The vehicle seat according to claim 7, wherein the second knit fabric includes the flame retardant fibers formed by polymerization of 3-hydroxyphenylphosphinyl-propanoic acid (3HPP), terephthalic acid, and ethylene glycol during polymerization of the terephthalic acid and the ethylene glycol.

12. The vehicle seat according to claim 7, wherein the first knit fabric is formed of polyethylene phthalate (PET) fibers.

13. A method for manufacturing a vehicle seat covering material comprising:
forming, by a circular knitting machine, a double-knit structured knit fabric composed of a first knit fabric and a second knit fabric provided to a surface of the first knit fabric and to include flame retardant fibers; and
dyeing the formed knit fabric.

14. The method according to claim 13, wherein the dyeing the formed knit fabric includes:
dyeing the knit fabric at a predetermined temperature for a predetermined time using the formed knit fabric, a dye, and a stabilizer.

15. The method according to claim 13, further comprising:
forming the vehicle seat covering material by thermally treating the dyed knit fabric.

16. The method according to claim 13, further comprising:
during fabrication of polyethylene phthalate (PET), forming the flame retardant fibers through polymerization of the polyethylene phthalate (PET) and phosphorous-based flame retardants.

17. The method according to claim 13, further comprising:
during fabrication of polyethylene phthalate (PET), forming the flame retardant fibers through polymerization of the polyethylene phthalate (PET) and 3-hydroxyphenylphosphinyl-propanoic acid (3HPP).

18. The method according to claim 13, further comprising:
during polymerization of terephthalic acid and ethylene glycol, forming the flame retardant fibers through polymerization of phosphorous-based flame retardants, the terephthalic acid, and the ethylene glycol.

19. The method according to claim 13, further comprising:
during polymerization of terephthalic acid and ethylene glycol, forming the flame retardant fibers through polymerization of 3-hydroxyphenylphosphinyl-propanoic acid (3HPP), the terephthalic acid, and the ethylene glycol.
